(19) United States
(12) Patent Application Publication
(10) Pub. No.: US 2005/0169152 A1
(43) Pub. Date: Aug. 4, 2005

(54) Optical pickup apparatus

(75) Inventors: Kohji Miyake, Higashihiroshima-shi (JP); Tatsushi Kojima, Higashihiroshima-shi (JP)

Correspondence Address: MORRISON & FOERSTER LLP, 755 PAGE MILL RD, PALO ALTO, CA, 94304-1018, US

(73) Assignee: SHARP KABUSHIKI KAISHA, Osaka-shi (JP)

(21) Appl. No.: 11/049,154

(22) Filed: Feb. 1, 2005

(30) Foreign Application Priority Data
Feb. 2, 2004 (JP) JP2004-025932

(51) Int. Cl. G11B 7/00

(52) U.S. Cl. 369/112.15; 369/112.1

(57) ABSTRACT

In correspondence to a hologram element of a hologram unit, on a light-path between the hologram element and an optical recording medium, a light blocking aperture for blocking, of a laser beam emitted from a light source, unnecessary lights other than an application light applied from the light source to an information recording surface of the optical recording medium and a reflection light reflected by the information recording surface of the optical recording medium and received by a light receiving element is formed. The light blocking aperture is provided with an unnecessary light guiding surface for guiding the unnecessary lights other than the application light and the reflection light in a direction other than a direction of the light receiving element. The unnecessary lights other than the application light and the reflection light can be securely prevented from entering into the light receiving element, and signals can be stably detected.

### BACKGROUND OF THE INVENTION

1. Field of the Invention

The present invention relates to an optical pickup apparatus that is suitably used in an optical disk apparatus that reads information of an optical recording medium such as a CD (Compact Disk) and a DVD (Digital Versatile Disk) and records information on the optical recording medium.

2. Description of the Related Art

An optical head apparatus of the related art has a diffraction element provided with aperture restricting means, thereby being structured so as to be capable of decreasing a generation amount of a diffraction light of an approach route generated when a beam of light emitted from a light source enters into the diffraction element before reaching a condensing optical system, and preventing that the diffraction light of the approach route is reflected by an optical recording medium and enters into a light receiving element (refer to Japanese Unexamined Patent Publication JP-A 10-208294 (1998), for example).

FIG. 9 is a simplified view showing a structure of an optical pickup apparatus 1 of the related art. The optical pickup apparatus 1 of the related art comprises a light source 2, a light receiving element 3, a hologram element 4, a stem 5, a lead electrode 6, a cap 7, a light blocking aperture 9, a collimating lens 10, an objective lens-11, and a housing 12. Moreover, the light source 2, the light receiving element 3, the hologram element 4, the stem 5, the lead electrode 6 and the cap 7 compose a hologram unit 8.

A laser beam emitted from the light source 2 passes through the hologram element 4, the light blocking aperture 9, the collimating lens 10 and the objective lens 11, and is condensed to an optical recording medium 13. The laser beam emitted from the light source 2 and reflected by the optical recording medium 13 tracks back the same light path as an approach route, that is, passes through the objective lens 11, the collimating lens 10 and the light blocking aperture 9 and enters into the hologram element 4. The laser beam entering into the hologram element 4 is diffracted through a diffracting action of the hologram element 4, and enters into the light receiving element 3 placed in a position corresponding to a diffraction direction thereof.

The optical pickup apparatus 1 has the light blocking aperture 9, thereby being structured so as to block a stray light generated when a reflection light such that the laser beam emitted from the light source 2 is reflected by an optical component such as the collimating lens 10, the laser beam that is not condensed to the optical recording medium of the laser beam emitted from the light source 2, and the laser beam emitted from the light source 2 and reflected by the optical recording medium 13 are reflected by an inner wall surface of the housing 12, and so as to prevent the stray light from entering into the light receiving element 3.

The optical pickup apparatus 1 of the related art blocks, with the light blocking aperture 9, a reflection light (occasionally referred to as a ‘first stray light’ hereafter) R1 such that the laser beam emitted from the light source 2 is reflected by the collimating lens 10, and prevents the first stray light R1 from entering into the light receiving element 3, but because it is provided with the light blocking aperture 9, a reflection light (occasionally referred to as a ‘second stray light’ hereafter) R2 such that the laser beam emitted from the light source 2 is reflected by the light blocking aperture 9 is newly generated, and the second stray light R2 enters into the light receiving element 3. Therefore, the optical pickup apparatus 1 of the prior art has a problem such that it cannot stably detect a focus error signal, a tracking error signal or an information signal.

### SUMMARY OF THE INVENTION

An object of the invention is to provide an optical pickup apparatus that is capable of preventing a stray light generated by a light blocking aperture from entering into a light receiving element and capable of stably detecting signals.

The invention provides an optical pickup apparatus comprising:
a hologram unit having a light source for emitting a laser beam of a predetermined wavelength band, a hologram element for diffracting the laser beam entering therein, and a light receiving element that is placed on a light path of a diffraction light diffracted by the hologram element so as to be adjacent to the light source in a direction perpendicular to a light axis of the laser beam; and
a light blocking member that is placed on the light path between the hologram element and an optical recording medium in correspondence to the hologram element of the hologram unit, the light blocking member blocking, of the laser beam, unnecessary lights other than an application light applied from the light source to the optical recording medium and a reflection light reflected by the optical recording medium and received by the light receiving element,
wherein the light blocking member has an unnecessary light guiding surface formed to face the light source, for guiding the unnecessary lights other than the application light and the reflection light in a direction other than a direction of the light receiving element.

Further, in the invention, the unnecessary light guiding surface of the light blocking member is a curved surface.

Still further, in the invention, the unnecessary light guiding surface of the light blocking member is a flat surface that forms an angle other than a right angle with respect to the light axis of the laser beam.

Still further, in the invention, the unnecessary light guiding surface of the light blocking member is a curved concave surface that faces the light receiving element.

Still further, in the invention, the unnecessary light guiding surface of the light blocking member is a flat surface that faces the light receiving element and forms an angle other than a right angle with respect to the light axis of the application light.

Still further, in the invention, the optical pickup apparatus further comprises light guiding means for guiding the laser beam emitted from the light source to the optical recording medium,
wherein the light guiding means is placed on the light path between the hologram element and the optical recording medium, and
the light blocking member is placed on the light path between the hologram element and the light guiding means.

Still further, in the invention, the light blocking member is formed in one body with the light guiding means.

Still further, in the invention, the light blocking member is formed in one body with the hologram element.

Still further, in the invention, the optical pickup apparatus further comprises a housing for holding the hologram unit, wherein the light blocking member is formed in one body with the housing.

Still further, in the invention, the unnecessary light guiding surface of the light blocking member is formed by a reflection preventing treatment for preventing reflection of the applied laser beam.

Still further, in the invention, the optical pickup apparatus further comprises a beam splitter, wherein a plurality of the hologram units and a plurality of the light blocking members are provided.

According to the invention, a light blocking member is placed on the light path between the hologram element and an optical recording medium in so correspondence to the hologram element of the hologram unit and block, of the laser beam emitted from the light source, unnecessary lights other than an application light applied from the light source to the optical recording medium and a reflection light reflected by the optical recording medium and received by the light receiving element. The light blocking member has an unnecessary light guiding surface formed to face the light source, and the unnecessary light guiding surface guides the unnecessary lights other than the application light and the reflection light in a direction other than a direction of the light receiving element.

By placing the light blocking member provided with the unnecessary light guiding surface on the light path between the hologram element and the optical recording medium as described above, it is possible to guide the unnecessary lights other than the application light applied from the light source to the optical recording medium and the reflection light reflected by the optical recoding medium and received by the light receiving element, for example, alight emitted from the light source and reflected by the unnecessary light guiding surface of the light blocking member, in the direction other than the direction of the light receiving element. Consequently, it is possible to securely prevent that the unnecessary lights other than the application light and the reflection light enter into the light receiving element, and it is possible to stably detect the focus error signal, the tracking-error signal and the information signal.

Further, according to the invention, the unnecessary light guiding surface of the light blocking member is a curved surface. Therefore, it is possible to guide, of the laser beam emitted from the light source, the unnecessary lights other than the application light applied from the light source to the optical recording medium and the reflection light reflected by the optical recording medium and received by the light receiving element, for example, the light emitted from the light source and reflected by the unnecessary light guiding surface of the light blocking member, in the direction other than the direction of the light receiving element. Consequently, it is possible to securely prevent the unnecessary lights other than the application light and the reflection light from entering into the light receiving element, and it is possible to stably detect the focus error signal, the tracking error signal and the information signal.

Still further, according to the invention, the unnecessary light guiding surface of the light blocking member is a flat surface that forms an angle other than a right angle with respect to the light axis of the laser beam. Therefore, it is possible to guide, of the laser beam emitted from the light source, the unnecessary lights other than the application light applied from the light source to the optical recording medium and the reflection light reflected by the optical recording medium and received by the light receiving element, for example, the light emitted from the light source and reflected by the unnecessary light guiding surface of the light blocking member, in the direction other than the direction of the light receiving element. Consequently, it is possible to securely prevent the unnecessary lights other than the application light and the reflection light from entering into the light receiving element, and it is possible to stably detect the focus error signal, the tracking error signal and the information signal.

Still further, according to the invention, the unnecessary light guiding surface of the light blocking member is a curved surface that has a concave shape facing the light receiving element. Therefore, it is possible to guide, of the laser beam emitted from the light source, the unnecessary lights other than the application light applied from the light source to the optical recording medium and the reflection light reflected by the optical recording medium and received by the light receiving element, for example, the light emitted from the light source and reflected by the unnecessary light guiding surface of the light blocking member, in the direction other than the direction of the light receiving element. Consequently, it is possible to securely prevent the unnecessary lights other than the application light and the reflection light from entering into the light receiving element, and it is possible to stably detect the focus error signal, the tracking error signal and the information signal.

Still further, according to the invention, the unnecessary light guiding surface of the light blocking member is a flat surface that faces the light receiving element and forms an angle other than a right angle with respect to the light axis of the application light. Therefore, it is possible to guide, of the laser beam emitted from the light source, the unnecessary lights other than the application light applied from the light source to the optical recording medium and the reflection light reflected by the optical recording medium and received by the light receiving element, for example, the light emitted from the light source and reflected by the unnecessary light guiding surface of the light blocking member, in the direction other than the direction of the light receiving element. Consequently, it is possible to securely prevent the unnecessary lights other than the application light and the reflection light from entering into the light receiving element, and it is possible to stably detect the focus error signal, the tracking error signal and the information signal.

Still further, according to the invention, on the light path between the hologram element and the optical recording medium, the light guiding means for guiding the laser beam emitted from the light source to the optical recording medium is placed. Thus, the light blocking member is placed on the light path between the hologram element and the light guiding means. By placing the light blocking member on the light path between the hologram element and the light guiding means, it is possible to securely block, of the laser beam emitted from the light source, the unnecessary lights other than the application light applied from the light source to the optical recording medium and the reflection light reflected by the optical recording medium and received by the light receiving element, for example, the light generated when the laser beam emitted from the light source is reflected by the light guiding means. Consequently, it is possible to securely prevent the light reflected by the light guiding means from entering into the light receiving element, and it is possible to stably detect the focus error signal, the tracking error signal and the information signal.

Still further, according to the invention, the light blocking member is formed in one body with the light guiding means. By forming the light blocking member in one body with the light guiding means in this way, the component count of optical components and the number of assembly processes at the time of production are reduced, and an optical adjustment operation such as an adjustment of a light axis is simplified, with the result that it is possible to increase the productivity of the optical pickup apparatus. Moreover, by reducing the component count of the optical components, it is possible to make the optical pickup apparatus small in size and light in weight, and it is possible to decrease the production cost of the optical pickup apparatus.

Still further, according to the invention, the light blocking member is formed in one body with the hologram element. By forming the light blocking member in one body with the hologram element in this way, the component count of the optical components and the number of the assembly processes at the time of production are reduced, and the optical adjustment operation such as the adjustment of the light axis is simplified, with the result that it is possible to increase the productivity of the optical pickup apparatus. Moreover, by reducing the component count of the optical components, it is possible to make the optical pickup apparatus small in size and light in weight, and it is possible to decrease the production cost of the optical pickup apparatus.

Still further, according to the invention, the light blocking member is formed in one body with the housing. By forming the light blocking member in one body with the housing in this way, the component count of the optical components and the number of the assembly processes at the time of production are reduced, and the optical adjustment operation such as the adjustment of the light axis is simplified, with the result that it is possible to increase the productivity of the optical pickup apparatus. Moreover, by reducing the component count of the optical components, it is possible to make the optical pickup apparatus small in size and light in weight, and it is possible to decrease the production cost of the optical pickup apparatus.

Still further, according to the invention, the unnecessary light guiding surface of the light blocking member is formed by the reflection preventing treatment for preventing reflection of the applied laser beam, so that the laser beam emitted from the light source is never reflected on the unnecessary light guiding surface of the light-blocking member. Therefore, it is possible to securely prevent that, as in the prior art, the laser beam emitted from the light source is reflected by the unnecessary light guiding surface of the light blocking member and enters into the light receiving element. Consequently, it is possible to stably detect the focus error signal, the tracking error signal and the information signal.

### BRIEF DESCRIPTION OF THE DRAWINGS

Other and further objects, features, and advantages of the invention will be more explicit from the following detailed description taken with reference to the drawings wherein:

FIG. 1 is a simplified view showing a structure of an optical pickup apparatus according to a first embodiment of the invention;

FIG. 2 is a simplified view showing a structure of an optical pickup apparatus according to a second embodiment of the invention;

FIG. 3 is a simplified view showing a structure of an optical pickup apparatus according to a third embodiment of the invention;

FIG. 4 is a simplified view showing a structure of an optical pickup apparatus according to a fourth embodiment of the invention;

FIG. 5 is a simplified view showing a structure of an optical pickup apparatus according to a fifth embodiment of the invention;

FIG. 6 is a simplified view showing a structure of an optical pickup apparatus according to a sixth embodiment of the invention;

FIG. 7 is a simplified view showing a structure of an optical pickup apparatus according to a seventh embodiment of the invention;

FIG. 8 is a simplified view showing a structure of an optical pickup apparatus according to an eighth embodiment of the invention; and

FIG. 9 is a simplified view showing a structure of an optical pickup apparatus of the related art.

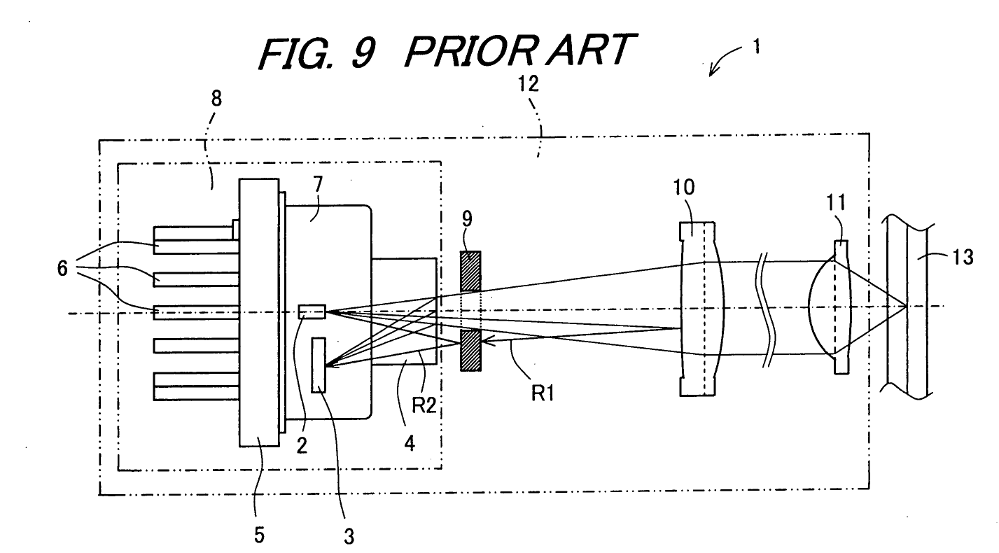

### DETAILED DESCRIPTION

Now referring to the drawings, preferred embodiments of the invention are described below.

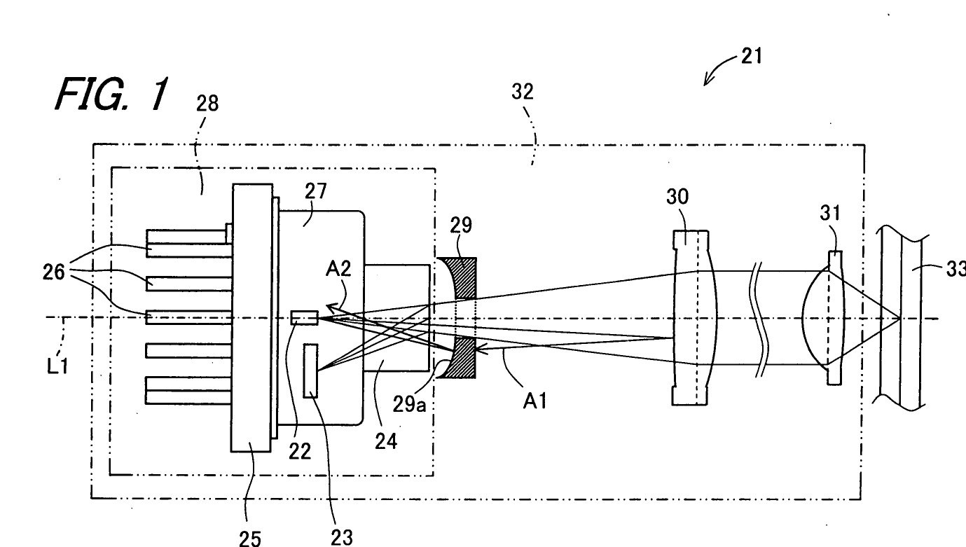

FIG. 1 is a simplified view showing a structure of an optical pickup apparatus 21 according to a first embodiment of the invention. As shown in FIG. 1, the optical pickup apparatus 21 comprises a light source 22, a light receiving element 23, a hologram element 24, a stem 25, a lead electrode 26, a cap 27, a light blocking aperture 29, a collimating lens 30, an objective lens 31, and a housing 32. In the embodiment, the light source 22, the light receiving element 23, the hologram element 24, the stem 25, the lead electrode 26 and the cap 27 compose a hologram unit 28.

The optical pickup apparatus 21 is an apparatus that performs at least one of processing of optically reading information recorded on an information recording surface of an optical recording medium 33 and processing of optically recording information to the information recording surface of the optical recording medium 33. The optical recording medium 33 is a CD (Compact Disk), a CD-R/RW (Compact Disk-Recordable/Rewritable), a DVD (Digital Versatile Disk) or the like.

The light source 22 is realized by, for example, a semiconductor laser element. At the time of reading of the information recorded on the information recording surface of the DVD, a semiconductor laser element that emits a laser beam of a red wavelength with an oscillation wavelength of, for example, 654 nm is used as the light source 22. At the time of reading of the information recorded on the information recording surface of the CD or the CD-R/RW and recording of the information on the information recording surface, a semiconductor laser element that emits a laser beam of an infrared wavelength with an oscillation wavelength of, for example, 784 nm is used as the light source 22.

The light receiving element 23 converts the laser beam emitted from the light source 22, reflected by the information recording surface of the optical recording medium 33, diffracted by the hologram element 24 described later and entering therein, to electric signals in accordance with the amount of a received light, and detects a focus error signal (abbreviated as FES), a tracking error signal (abbreviated as TES) and an information signal (abbreviated as RF) of the optical recording medium on the basis of the electric signals. The light receiving element 23 is realized by, for example, a photodiode. The light receiving element 23 is placed on a light path of a diffraction light diffracted by the hologram element 24 described later so as to be adjacent to the light source in a direction perpendicular to a light axis L1 of an application light emitted from the light source 22 and applied to the optical recording medium 33.

The hologram element 24 includes a three-beam diffraction grating and a hologram diffraction grating, which are not shown in the drawing. The three-beam diffraction grating is formed on a surface of the hologram element 24 that crosses, at right angles, the light axis L1 of the application light emitted from the light source 22 and applied to the optical recording medium 33 and faces the light source 22. The hologram diffraction grating is formed on a surface opposite to the surface on which the three-beam diffraction-grating is formed.

The three-beam diffraction grating diffracts the laser beam entering therein, thereby splitting the laser beam to one main beam and two sub beams. The hologram diffraction grating has a diffraction characteristic of diffracting the laser beam entering therein. With the diffraction characteristic, the light emitted from the light source 22, reflected by the information recording surface of the optical recording medium 33 and entering into the hologram diffraction grating is diffracted in a predetermined direction of the light receiving element 23.

The light source 22 and the light receiving element 23 are placed on the side of one surface of the stem 25. The lead electrode 26 is disposed so as to protrude from the side of the other surface of the stem 25, and electrically connected to the light source 22. When a driving voltage and a driving current are supplied to the light source 22 via the lead electrode 26, the laser beam of a predetermined oscillation wavelength band is emitted from the light source 22.

The cap 27 is a sealing member for sealing in the light source 22 and the light receiving element 23 so as to avoid physical contact of the light source 22 and the light receiving element 23 with the outside, and is mounted on the side of the one surface of the stem 25. Consequently, the light source 22 and the light receiving element 23 are sealed off by the stem 25 and the cap 27.

The light blocking aperture 29 serving as a light blocking member blocks, of the laser beam emitted from the light source 22, unnecessary lights other than the application light applied from the light source 22 to the optical recording medium 33 and a reflection light reflected by the information recording surface of the optical recording medium 33 and received by the light receiving element 23. In the embodiment, the light blocking aperture 29 is placed on the light path between the hologram element 24 and the collimating lens 30, which is an optical component that is the closest to the hologram element 24. The light blocking aperture 29 is made of a polycarbonate (abbreviated as PC) resin, an acrylonitrile-butadiene-styrene copolymer (abbreviated as ABS) resin, a polyphenylene sulfide (abbreviated as PPS) resin or the like.

The collimating lens 30 collimates the laser beam emitted from the light source 22 and passing through the hologram element 24 and the light blocking aperture 29, and guides to the objective lens 31 described later. The objective lens 31 condenses the light from the collimating lens 30 to the information recording surface of the optical recording medium 33. In the embodiment, the collimating lens 30 and the objective lens 31 are placed on the light path between the hologram element 24 and the optical recording medium 33. In the embodiment, the collimating lens 30 and the objective lens 31 are equivalent to light guiding means. The housing 32 holds the hologram unit 28, the collimating lens 30 and the objective lens 31.

In the optical pickup apparatus 21, of the laser beam emitted from the light source 22, the unnecessary lights other than the application light applied from the light source 22 and applied to the optical recording medium 33 and the reflection light reflected by the information recording surface of the optical recording medium and received by the light receiving element 23 are reflected by an inner wall surface of the housing 32 and an optical component such as the collimating lens 30, whereby a so-called stray light is generated. It is thought that detection of signals such as the FES, the TES and the RF is often affected specifically when, of the stray light, a stray light (occasionally referred to as a ‘first stray light’ hereafter) A1 generated by reflection by the optical component that is the closest to the hologram element 24 of the hologram unit 28, that is, the collimating lens 30 in the embodiment enters into the light receiving element 23. Accordingly, in the embodiment, the light blocking aperture 29 is placed on the light path between the hologram element 24 of the hologram unit 28 and the collimating lens 30 of the optical component that is the closest to the hologram element 24 as described above.

The stray light generated in the optical pickup apparatus 21 is not only the first stray light A1, but also a stray light (occasionally referred to as a ‘second stray light’ hereafter) A2 generated when the laser beam emitted from the light source 22 is reflected by the surface of the light blocking aperture 29 placed for blocking the first stray light A1, the surface crossing the light axis L1 at right angles and facing the light source 22. Therefore, in the embodiment, on the surface of the light blocking aperture 29 that crosses the light axis L1 at right angles and faces the light source 22, an unnecessary light guiding surface 29a for guiding the second stray light A2 in a direction other than a direction of the light receiving element 23 is formed. The unnecessary light guiding surface 29a of the light blocking aperture 29 in the embodiment is a curved surface that has a concave shape facing the hologram element 24. Describing in detail, in the unnecessary light guiding surface 29a, a portion from a central portion in a direction perpendicular to the light axis L1 in the light blocking aperture 29 (occasionally referred to as a ‘longitudinal direction’ hereafter) toward both end portions in the longitudinal direction is curved like an arc so as to separate, toward one side in a thickness direction facing the hologram element 24 close to the hologram element 24 of the light blocking aperture 29, from another side in the thickness direction opposite to the one side in the thickness direction as it goes to both the end portions in the longitudinal direction. The light blocking aperture 29 provided with the unnecessary light guiding surface 29a is formed by, for example, injection molding.

When the driving voltage and the driving current are supplied to the light source 22 via the lead electrode 26 disposed to the stem 25, the laser beam of the predetermined oscillation wavelength band is emitted from the light source 22. The laser beam emitted from the light source 22 enters into the three-beam diffraction grating of the hologram element 24. The laser beam entering into the three-beam diffraction grating is split to one main beam and two sub beams. In a description below, when at least one of the main beam and the respective sub beams is mentioned, it may be simply referred to as ‘light.’

The light passing through the three-beam diffraction grating enters into the hologram diffraction grating of the hologram element 24. The light entering into the hologram diffraction grating is diffracted in a specified diffraction direction. The light passing through the hologram element 24 passes through the light blocking aperture 29, and enters into the collimating lens 30. The light entering into the collimating lens 30 is collimated. The light collimated by the collimating lens 30 enters into the objective lens 31. The objective lens 31 condenses the light entering therein to the information recording surface of the optical recording medium 33.

The light reflected by the information recording surface of the optical recording medium 33 tracks back the same light path as an approach route. The light reflected by the information recording surface of the optical recording medium 33 enters into the objective lens 31 to become a parallel light, passes through the collimating lens 30 and the light blocking aperture 29, and enters into the hologram diffraction grating of the hologram element 24. The light entering into the hologram diffraction grating after being reflected by the information recording surface of the optical recording medium 33 is diffracted, and enters into the light receiving element 23.

According to the embodiment, the light blocking aperture 29 is placed on the light path between the hologram element 24 and the collimating lens 30 of the optical component that is the closest to the hologram element 24, so that the first stray light A1 generated when the light emitted from the light source 22 is reflected by, for example, the collimating lens 30 is blocked by the light blocking aperture 29. Therefore, it is possible to securely prevent the first stray light A1 from entering into the light receiving element 23, and it is possible to stably detect the focus error signal, the tracking error signal and the information signal.

Further, in the embodiment, the unnecessary light guiding surface 29a, which is a curved surface having a concave shape, is formed on the surface of the light blocking aperture 29 that crosses the light axis L1 at right angles and faces the light source 22, so that it is possible to guide the second stray light A2 generated when the light emitted from the light source 22 is reflected by the unnecessary light guiding surface 29a, in the direction other than the direction of the light receiving element 23. Consequently, it is possible to securely prevent the second stray light A2 from entering into the light receiving element 23, and it is possible to stably detect the focus error signal, the tracking error signal and the information signal.

Further, considering a case where a scattering light is generated because the unnecessary light guiding surface 29a of the light blocking aperture 29 is rough, the unnecessary light guiding surface 29a may be formed by a reflection preventing treatment in order to prevent generation of the scattering light. The reflection preventing treatment is, for example, to form a reflection preventing film on the surface of the light blocking aperture 29 that faces the light source 22, or to apply surface processing to the surface of the light blocking aperture 29 that faces the light source 22.

In the case of forming the reflection preventing film, for example, black matte lacquer is sprayed and applied to the surface of the light blocking aperture 29 that faces the light source 22. Moreover, in the case of applying the surface processing, by applying a so-called unevenness treatment by etching to a surface of a die used at the time of injection molding, microscopic asperities are formed on the surface of the die.

By forming the unnecessary light guiding surface 29a by the reflection preventing treatment described above, the laser beam emitted from the light source 22 is not reflected but absorbed by the unnecessary light guiding surface 29a. Therefore, it is possible to prevent generation of the scattering light. Accordingly, it is possible to prevent the scattering light from entering into the light receiving element 23, and it is possible to stably detect the focus error signal, the tracking error signal and the information signal.

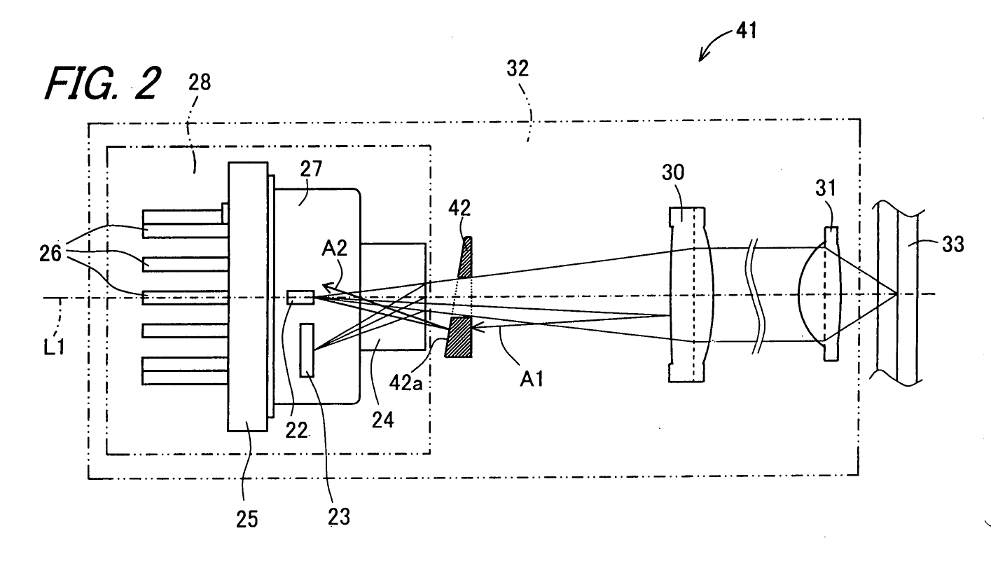

FIG. 2 is a simplified view showing a structure of an optical pickup apparatus 41 according to a second embodiment of the invention. Since the embodiment is similar to the first embodiment, corresponding portions will be denoted by the same reference numerals, and a description thereof will be omitted. A light blocking aperture 42 serving as the light blocking member blocks, of the laser beam emitted from the light source 22, the unnecessary lights other than the application light applied from the light source 22 to the optical recording medium 33 and the reflection light reflected by the information recording surface of the optical recording medium 33 and received by the light receiving element 23. In the embodiment, the light blocking aperture 42 is placed on the light path between the hologram element 24 and the collimating lens 30 of the optical component that is the closest to the hologram element 24.

In the optical pickup apparatus 41, as in the optical pickup apparatus 21, of the laser beam emitted from the light source 22, the unnecessary lights other than the application light applied from the light source 22 to the optical recording medium 33 and the reflection light reflected by the information recording surface of the optical recording medium 33 and received by the light receiving element 23 are reflected by the inner wall surface of the housing 32 and the optical component such as the collimating lens 30, whereby the so-called stray light is generated. It is thought that detection of signals such as the FES, the TES and the RF is often affected specifically when, of the stray light, the stray light (occasionally referred to as the ‘first stray light’ hereafter) A1 generated by reflection by the optical component that is the closest to the hologram element 24 of the hologram unit 28, that is, the collimating lens 30 in the embodiment enters into the light receiving element 23. Then, in the embodiment, as in the first embodiment, the light blocking aperture 42 is placed on the light path between the hologram element 24 of the hologram unit 28 and the collimating lens 30 of the optical component that is the closest to the hologram element 24.

The light blocking aperture 42 is made of a polycarbonate (abbreviated as PC) resin, an acrylonitrile-butadiene-styrene copolymer (abbreviated as ABS) resin, a polyphenylene sulfide (abbreviated as PPS) resin or the like.

The stray light generated in the optical pickup apparatus 41 is not only the first stray light A1, but also the stray light (occasionally referred to as the ‘second stray light’ hereafter) A2 generated when the laser beam emitted from the light source 22 is reflected by a surface of the light blocking aperture 42 placed for blocking the first stray light A1, the surface crossing the light axis L1 at right angles and facing the light source 22. Therefore, in the embodiment, on the surface of the light blocking aperture 42 that crosses the light axis L1 at right angles and faces the light source 22, an unnecessary light guiding surface 42a for guiding the second stray light A2 in the direction other than the direction of the light receiving element 23 is formed. The unnecessary light guiding surface 42a of the light blocking aperture 42 in the embodiment is a flat surface that forms an angle other than a right angle with respect to the optical axis L1 of the application light emitted from the light source 22 and applied to the optical recording medium 33. Describing in detail, in the unnecessary light guiding surface 42a, a portion from one end portion in a direction perpendicular to the light axis L1 in the light blocking aperture 42 (occasionally referred to as a ‘longitudinal direction’ hereafter) toward the other end portion is inclined so as to come close to one side in a thickness direction opposite to another side in the thickness direction facing the hologram element 24 of the light blocking aperture 42 as it goes from the one end portion in the longitudinal direction to the other end portion in the longitudinal direction. The light blocking aperture 42 provided with the unnecessary light guiding surface 42a is formed by, for example, injection molding.

According to the embodiment, the light blocking aperture 42 is placed on the light path between the hologram element 24 and the collimating lens 30 of the optical component that is the closest to the hologram element 24, so that the first stray light A1 generated when the light emitted from the light source 22 is reflected by, for example, the collimating lens 30 is blocked by the light blocking aperture 42. Therefore, it is possible to securely prevent the first stray light A1 from entering into the light receiving element 23, and it is possible to stably detect the focus error signal, the tracking error signal and the information signal.

Further, in the embodiment, the unnecessary light guiding surface 42a of a flat surface that forms an angle other than a right angle with respect to the light axis L1 of the application light is formed on the surface of the light blocking aperture 42 that crosses the light axis L1 at right angles and faces the light source 22, so that it is possible to guide the second stray light A2 generated when the light emitted from the light source 22 is reflected by the unnecessary light guiding surface 42a, in the direction other than the direction of the light receiving element 23. Consequently, it is possible to securely prevent the second stray light A2 from entering into the light receiving element 23, and it is possible to stably detect the focus error signal, the tracking error signal and the information signal.

Further, considering a case where the scattering light is generated because the unnecessary light guiding surface 42a of the light blocking aperture 42 is rough, the unnecessary light guiding surface 42a may be formed by the reflection preventing treatment in order to prevent generation of the scattering light. The reflection preventing treatment is, for example, to form the reflection preventing film on the surface of the light blocking aperture 42 that faces the light source 22, or to apply the surface processing to the surface of the light blocking aperture 42 that faces the light source 22.

In the case of forming the reflection preventing film, for example, black matte lacquer is sprayed and applied to the surface of the light blocking aperture 42 that faces the light source 22. Moreover, in the case of applying the surface processing, by applying the so-called unevenness treatment by etching to the surface of the die used at the time of injection molding, microscopic asperities are formed on the surface of the die.

By forming the unnecessary light guiding surface 42a by the reflection preventing treatment described above, the laser beam emitted from the light source 22 is not reflected but absorbed by the unnecessary light guiding surface 42a. Therefore, it is possible to prevent generation of the scattering light. Accordingly, it is possible to prevent the scattering light from entering into the light receiving element 23, and it is possible to stably detect the focus error signal, the tracking error signal and the information signal.

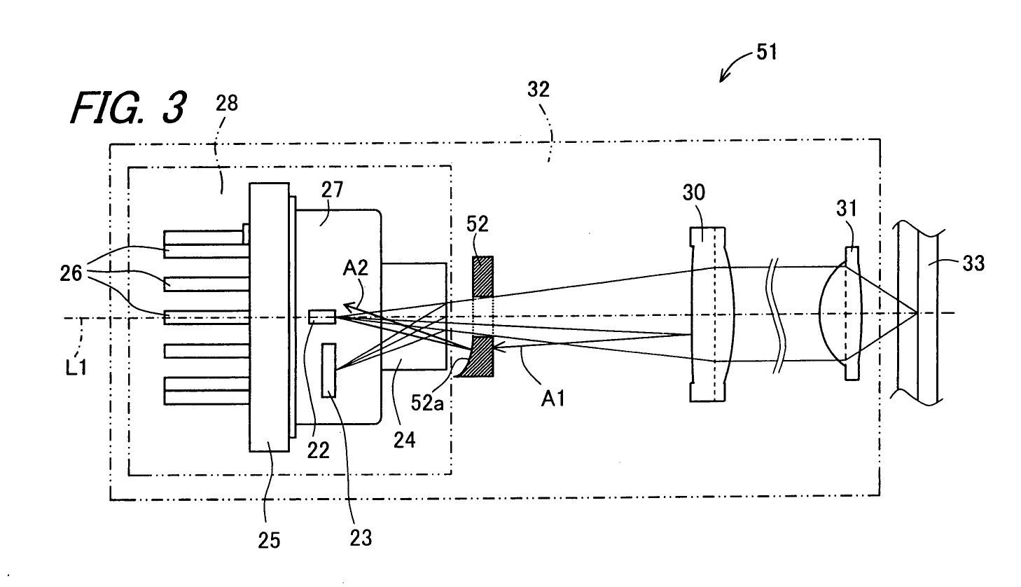

FIG. 3 is a simplified view showing a structure of an optical pickup apparatus 51 according to a third embodiment of the invention. Since the embodiment is similar to the first embodiment, corresponding portions will be denoted by the same reference numerals, and a description thereof will be omitted. A light blocking aperture 52 serving as the light blocking member blocks, of the laser beam emitted from the light source 22, the unnecessary lights other than the application light applied from the light source 22 to the optical recording medium 33 and the reflection light reflected by the information recording surface of the optical recording medium 33 and received by the light receiving element 23. In the embodiment, the light blocking aperture 52 is placed on the light path between the hologram element 24 and the collimating lens 30 of the optical component that is the closest to the hologram element 24.

In the optical pickup apparatus 51, as in the optical pickup apparatus 21, of the laser beam emitted from the light source 22, the unnecessary lights other than the application light applied from the light source 22 to the optical recording medium 33 and the reflection light reflected by the information recording surface of the optical recording medium 33 and received by the light receiving element 23 are reflected by the inner wall surface of the housing 32 and the optical component such as the collimating lens 30, whereby the so-called stray light is generated. It is thought that detection of signals such as the FES, the TES and the RF is often affected specifically when, of the stray light, the stray light (occasionally referred to as the ‘first stray light’ hereafter) A1 generated by reflection by the optical component that is the closest to the hologram element 24 of the hologram unit 28, that is, the collimating lens 30 in the embodiment enters into the light receiving element 23. Then, in the embodiment, as in the first and second embodiments, the light blocking aperture 52 is placed on the light path between the hologram element 24 of the hologram unit 28 and the collimating lens 30 of the optical component that is the closest to the hologram element 24.

The light blocking aperture 52 is made of a polycarbonate (abbreviated as PC) resin, an acrylonitrile-butadiene-styrene copolymer (abbreviated as ABS) resin, a polyphenylene sulfide (abbreviated as PPS) resin or the like.

The stray light generated in the optical pickup apparatus 51 is not only the first stray light A1, but also the stray light (occasionally referred to as the ‘second stray light’ hereafter) A2 generated when the laser beam emitted from the light source 22 is reflected by a surface of the light blocking aperture 52 placed for blocking the first stray light A1, the surface crossing the light axis L1 at right angles and facing the light source 22. Therefore, in the embodiment, on the surface of the light blocking aperture 52 that crosses the light axis L1 at right angles and faces the light source 22, an unnecessary light guiding surface 52a for guiding the second stray light A2 in the direction other than the direction of the light receiving element 23 is formed. The unnecessary light guiding surface 52a of the light blocking aperture 52 in the embodiment is a curved surface that has a concave shape facing the light receiving surface 23. Describing in detail, in the unnecessary light guiding surface 52a, a portion from a central portion in a direction perpendicular to the light axis L1 in the light blocking aperture 52 (occasionally referred to as the ‘longitudinal direction’ hereafter) toward one end portion in the longitudinal direction is curved like an arc so as to separate, toward one side in a thickness direction facing the hologram element 24 close to the hologram element 24 of the light blocking aperture 52, from another side in the thickness direction opposite to the one side in the thickness direction as it goes to the one end portion in the longitudinal direction. The light blocking aperture 52 provided with the unnecessary light guiding surface 52a is formed by injection molding, for example.

According to the embodiment, the light blocking aperture 52 is placed on the light path between the hologram element 24 and the collimating lens 30 of the optical component that is the closest to the hologram element 24, so that the first stray light A1 generated when the light emitted from the light source 22 is reflected by, for example, the collimating lens 30 is blocked by the light blocking aperture 52. Therefore, it is possible to securely prevent the first stray light A1 from entering into the light receiving element 23, and it is possible to stably detect the focus error signal, the tracking error signal and the information signal.

Further, in the embodiment, the unnecessary light guiding surface 52a of a curved surface that has a concave shape facing the light receiving element 23 is formed on the surface of the light blocking aperture 52 that crosses the light axis L1 at right angles and faces the light source 22, so that it is possible to guide the second stray light A2 generated when the light emitted from the light source 22 is reflected by the unnecessary light guiding surface 52a, in the direction other than the direction of the light receiving element 23. Consequently, it is possible to securely prevent the second stray light A2 from entering into the light receiving element 23, and it is possible to stably detect the focus error signal, the tracking error signal and the information signal.

Further, considering a case where a scattering light is generated because the unnecessary light guiding surface 52a of the light blocking aperture 52 is rough, the unnecessary light guiding surface 52a may be formed by the reflection preventing treatment in order to prevent generation of the scattering light. The reflection preventing treatment is, for example, to form the reflection preventing film on the surface of the light blocking aperture 52 that faces the light source 22, or to apply the surface processing to the surface of the light blocking aperture 52 that faces the light source 22.

In the case of forming the reflection preventing film, for example, black matte lacquer is sprayed and applied to the surface of the light blocking aperture 52 that faces the light source 22. Moreover, in the case of applying the surface processing, by applying the so-called unevenness treatment by etching to the surface of the die used at the time of injection molding, microscopic asperities are formed on the surface of the die.

By forming the unnecessary light guiding surface 52a by the reflection preventing treatment described above, the laser beam emitted from the light source 22 is not reflected but absorbed by the unnecessary light guiding surface 52a. Therefore, it is possible to prevent generation of the scattering light. Accordingly, it is possible to prevent the scattering light from entering into the light receiving element 23, and it is possible to stably detect the focus error signal, the tracking error signal and the information signal.

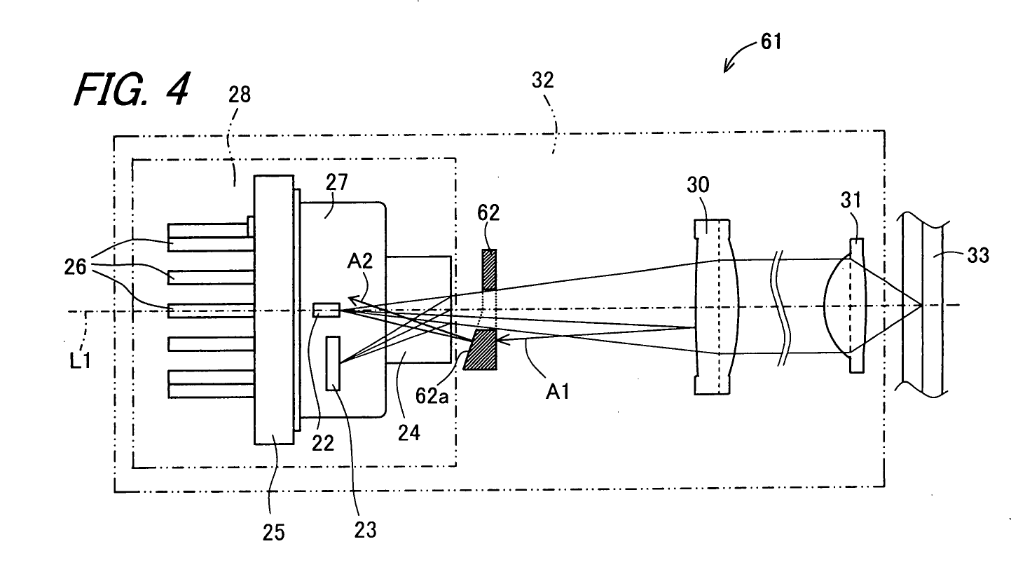

FIG. 4 is a simplified view showing a structure of an optical pickup apparatus 61 according to a fourth embodiment of the invention. Since the embodiment is similar to the first embodiment, corresponding portions will be denoted by the same reference numerals, and a description thereof will be omitted. A light blocking aperture 62 serving as the light blocking member blocks, of the laser beam emitted from the light source 22, the unnecessary lights other than the application light applied from the light source 22 to the optical recording medium 33 and the reflection light reflected by the information recording surface of the optical recording medium 33 and received by the light receiving element 23. In the embodiment, the light blocking aperture 62 is placed on the light path between the hologram element 24 and the collimating lens 30 of the optical component that is the closest to the hologram element 24.

In the optical pickup apparatus 61, as in the optical pickup apparatus 21, of the laser beam emitted from the light source 22, the unnecessary lights other than the application light applied from the light source 22 to the optical recording medium 33 and the reflection light reflected by the information recording surface of the optical recording medium 33 and received by the light receiving element 23 are reflected by the inner wall surface of the housing 32 and the optical component such as the collimating lens 30, whereby the so-called stray light is generated. It is thought that detection of signals such as the FES, the TES and the RF is often affected specifically when, of the stray light, the stray light (occasionally referred to as the ‘first stray light’ hereafter) A1 generated by reflection by the optical component that is the closest to the hologram element 24 of the hologram unit 28, that is, the collimating lens 30 in the embodiment enters into the light receiving element 23. Then, in the embodiment, as in the first and third embodiments, the light blocking aperture 62 is placed on the light path between the hologram element 24 of the hologram unit 28 and the collimating lens 30 of the optical component that is the closest to the hologram element 24.

The light blocking aperture 62 is made of a polycarbonate (abbreviated as PC) resin, an acrylonitrile-butadiene-styrene copolymer (abbreviated as ABS) resin, a polyphenylene sulfide (abbreviated as PPS) resin or the like.

The stray light generated in the optical pickup apparatus 61 is not only the first stray light A1, but also the stray light (occasionally referred to as the ‘second stray light’ hereafter) A2 generated when the laser beam emitted from the light source 22 is reflected by a surface of the light blocking aperture 62 placed for blocking the first stray light A1, the surface crossing the light axis L1 at right angles and facing the light source 22. Therefore, in the embodiment, on the surface of the light blocking aperture 62 that crosses the light axis L1 at right angles and faces the light source 22, an unnecessary light guiding surface 62a for guiding the second stray light A2 in the direction other than the direction of the light receiving element 23 is formed. An unnecessary light guiding surface 62a of the light blocking aperture 62 in the embodiment is a flat surface that faces the light receiving element 23 and forms an angle other than a right angle with respect to the light axis L1 of the application light applied from the light source 22 to the optical recording medium 33. Describing in detail, in the unnecessary light guiding surface 62a, a portion from one end portion in a direction perpendicular to the light axis L1 in the light blocking aperture 62 (occasionally referred to as the ‘longitudinal direction’ hereafter) toward a central portion is inclined so as to come close to one side in a thickness direction opposite to another side in the thickness direction facing the hologram element 24 of the light blocking aperture 62 as it goes form one end portion in the longitudinal direction to the central portion in the longitudinal direction. The light blocking aperture 62 provided with the unnecessary light guiding surface 62a is formed by injection molding, for example.

According to the embodiment, the light blocking aperture 62 is placed on the light path between the hologram element 24 and the collimating lens 30 of the optical component that is the closest to the hologram element 24, so that the first stray light A1 generated when the light emitted from the light source 22 is reflected by, for example, the collimating lens 30 is blocked by the light blocking aperture 62. Therefore, it is possible to securely prevent the first stray light A1 from entering into the light receiving element 23, and it is possible to stably detect the focus error signal, the tracking error signal and the information signal.

Further, in the embodiment, the unnecessary light guiding surface 62a of a flat surface that forms an angle other than a right angle with respect to the light axis L1 of the application light is formed on the surface of the light blocking aperture 62 that crosses the light axis L1 at right angles and faces the light source 22, so that it is possible to guide the second stray light A2 generated when the light emitted from the light source 22 is reflected by the unnecessary light guiding surface 62a, in the direction other than the direction of the light receiving element 23. Consequently, it is possible to securely prevent the second stray light A2 from entering into the light receiving element 23, and it is possible to stably detect the focus error signal, the tracking error signal and the information signal.

Further, considering a case where a scattering light is generated because the unnecessary light guiding surface 62a of the light blocking aperture 62 is rough, the unnecessary light guiding surface 62a may be formed by the reflection preventing treatment in order to prevent generation of the scattering light. The reflection preventing treatment is, for example, to form the reflection preventing film on the surface of the light blocking aperture 62 that faces the light source 22, or to apply the surface processing to the surface of the light blocking aperture 62 that faces the light source 22.

In the case of forming the reflection preventing film, for example, black matte lacquer is sprayed and applied to the surface of the light blocking aperture 62 that faces the light source 22. Moreover, in the case of applying the surface processing, by applying the so-called unevenness treatment by etching to the surface of the die used at the time of injection molding, microscopic asperities are formed on the surface of the die.

By forming the unnecessary light guiding surface 62a by the reflection preventing treatment described above, the laser beam emitted from the light source 22 is not reflected but absorbed by the unnecessary light guiding surface 62a. Therefore, it is possible to prevent generation of the scattering light. Accordingly, it is possible to prevent the scattering light from entering into the light receiving element 23, and it is possible to stably detect the focus error signal, the tracking error signal and the information signal.

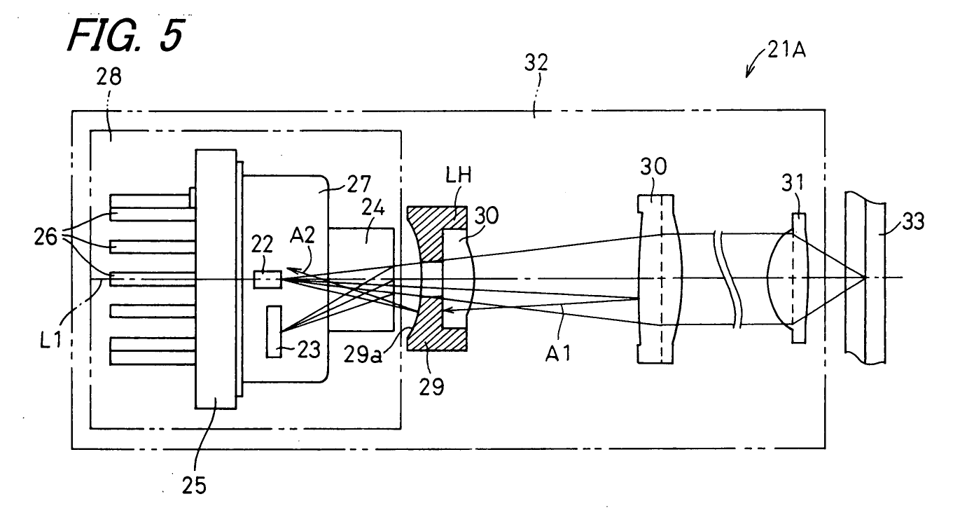

In the first to fourth embodiments described above, the light blocking aperture 29, 42, 52 or 62 may be formed in one body with the collimating lens 30 of the optical component that is the closest to the hologram element 24 of the hologram unit 28. FIG. 5 is a simplified view showing a structure of an optical pickup apparatus 21A according to a fifth embodiment of the invention. In the embodiment, a case where the light blocking aperture 29 according to the first embodiment of the invention is used will be described. For example, the light blocking aperture 29 is formed in a lens holder LH used at the time of installation of the collimating lens 30 into the housing 32, and the lens holder LH in which the light blocking aperture 29 and the collimating lens 30 are integrated and installed into the housing 32. It is noted that, although the light blocking aperture 29 is used in the embodiment, the light blocking apertures 42, 52 or 62 according to any of the second to fourth embodiments of the invention may be used instead of the light blocking aperture 29.

By forming the light blocking aperture 29, 42, 52 or 62 in one body with the collimating lens 30 of the optical component that is the closest to the hologram element 24 of the hologram unit 28 as described above, the component count of optical components and the number of assembly processes at the time of production are reduced, and an optical adjustment operation such as an adjustment of a light axis is simplified, with the result that it is possible to increase the productivity of the optical pickup apparatus.

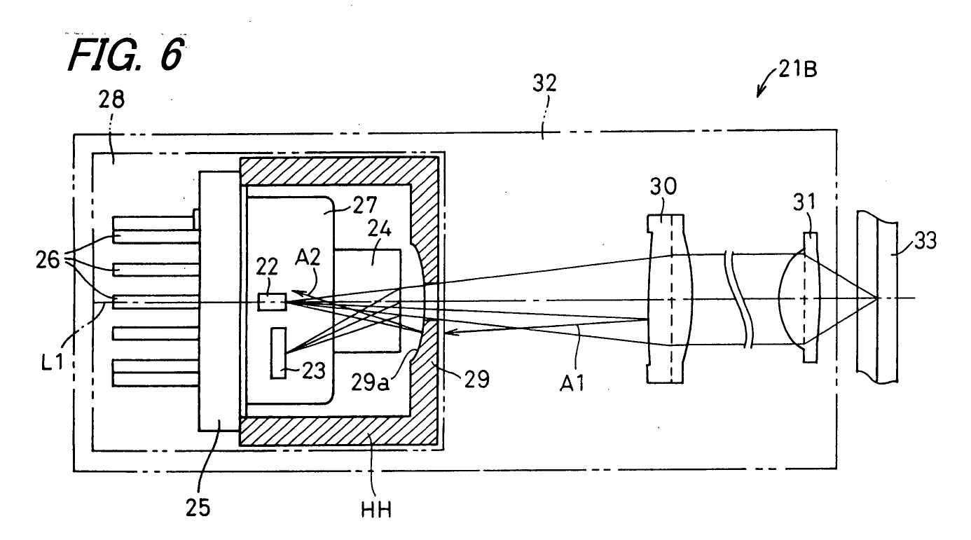

Further, in the first to fourth embodiments described above, the light blocking aperture 29, 42, 52 or 62 may be formed in one body with the hologram element 24 of the hologram unit 28. FIG. 6 is a simplified view showing a structure of an optical pickup apparatus 21B according to a sixth embodiment of the invention. In the embodiment, a case where the light blocking aperture 29 according to the first embodiment of the invention is used will be described. At the time of assembly of the optical pickup apparatus 21B, it is necessary to perform the optical adjustment operation such as an adjustment of a light axis of the hologram unit 28. The optical adjustment operation of the hologram unit 28 is performed by fitting the hologram unit 28 into a hologram unit holder HH for holding the hologram unit 28, and grasping the hologram unit holder HH. Then, by forming the light blocking aperture 29 in the hologram unit holder HH, and fitting the hologram unit 28 into the hologram unit holder HH in which the light blocking aperture 29 is formed, the light blocking aperture 29 and the hologram element 24 of the hologram unit 28 are integrated. It is noted that, although the light blocking aperture 29 is used in the embodiment, the light blocking apertures 42, 52 or 62 according to any of the second to fourth embodiments of the invention may be used instead of the light blocking aperture 29.

By forming the light blocking aperture 29, 42, 52 or 62 in one body with the hologram element 24 of the hologram unit 28 as described above, the component count of the optical components and the number of the assembly processes at the time of production are reduced, and the optical adjustment operation such as the adjustment of the light axis is simplified, with the result that it is possible to increase the productivity of the optical pickup apparatus.

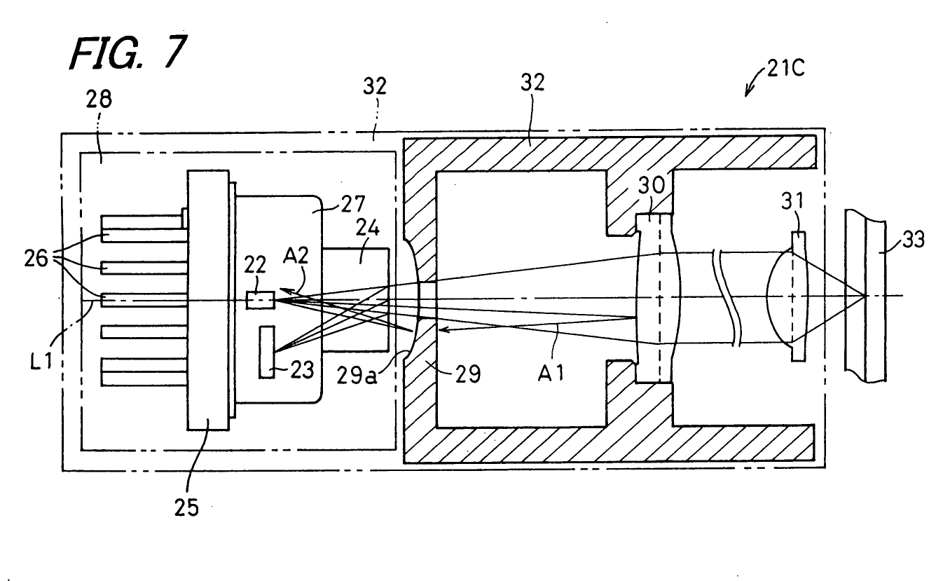

Still further, in the first to fourth embodiments described above, the light blocking aperture 29, 42, 52 or 62 may be formed in one body with the housing 32. FIG. 7 is a simplified view showing a structure of an optical pickup apparatus 21C according to a seventh embodiment of the invention. In the embodiment, a case where the light blocking aperture 29 according to the first embodiment of the invention is used will be described. As shown in FIG. 7, the light blocking aperture 29 is formed in one body with the housing 32 at the closest position to the hologram element 24. Thereby, the component count of the optical components and the number of the assembly processes at the time of production are reduced, and the optical adjustment operation such as the adjustment of the light axis is simplified, with the result that it is possible to increase the productivity of the optical pickup apparatus. It is noted that, although the light blocking aperture 29 is used in the embodiment, the light blocking apertures 42, 52 or 62 according to any of the second to fourth embodiments of the invention may be used instead of the light blocking aperture 29.

Further, by reducing the component count of the optical components as described above, it is possible to make the optical pickup apparatus small in size and light in weight, and it is possible to decrease the manufacturing cost of the optical pickup apparatus.

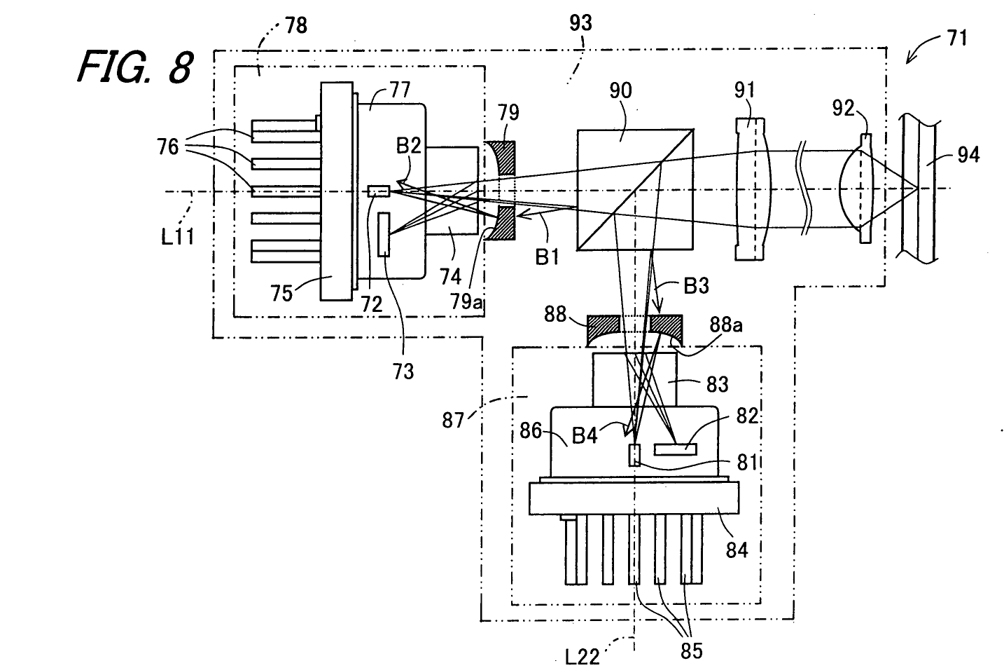

FIG. 8 is a simplified view showing a structure of an optical pickup apparatus 71 according to an eighth embodiment of the invention. As shown in FIG. 8, the optical pickup apparatus 71 comprises a first light source 72, a first light receiving element 73, a first hologram element 74, a first stem 75, a first lead electrode 76, a first cap 77, a first light blocking aperture 79, a second light source 81, a second light receiving element 82, a second hologram element 83, a second stem 84, a second lead electrode 85, a second cap 86, a second light blocking aperture 88, a beam splitter 90, a collimating lens 91, an objective lens 92, and a housing 93.

In the embodiment, the first light source 72, the first light receiving element 73, the first hologram element 74, the first stem 75, the first lead electrode 76 and the first cap 77 compose a first hologram unit 78. The second light source 81, the second light receiving element 82, the second hologram element 83, the second stem 84, the second lead electrode 85 and the second cap 86 compose a second hologram unit 87.

The first light source 72 and the second light source 81 are realized by semiconductor laser elements, for example. The oscillation wavelength band of a laser beam emitted from the first light source 72 and the oscillation wavelength band of a laser beam emitted from the second light source 81 are different from each other. The first light source 72 is realized by a semiconductor laser element that emits a laser beam of a red wavelength with an oscillation wavelength of, for example, 654 nm so as to read information recorded on the information recording surface of, for example, a DVD. The second light source 81 is realized by a semiconductor laser element that emits a laser beam of an infrared wavelength with an oscillation wavelength of, for example, 784 nm so as to read information recorded on the information recording surface of, for example, a CD or a CD-R/RW and record information on the information recording surface.

The first light receiving element 73 converts the laser beam emitted from the first light source 72, reflected by the information recording surface of an optical recording medium 94, diffracted by the first hologram element 74 described later and entering therein, to electric signals in accordance with the amount of a received light, and detects a focus error signal (abbreviated as FES), a tracking error signal (abbreviated as TES) and an information signal (abbreviated as RF) of the optical recording medium on the basis of the electric signals. The first light receiving element 73 is placed on a light path of a diffraction light diffracted by the first hologram element 74 described later so as to be adjacent to the first light source 72 in a direction perpendicular to a light axis (occasionally simply referred to as a ‘first light axis’ hereafter) L11 of an application light emitted from the first light source 72 and applied to the optical recording medium 94.

The second light receiving element 82 converts the laser beam emitted from the second light source 81, reflected by the information recording surface of the optical recording medium 94, diffracted by the second hologram element 83 described later and entering therein, to electric signals in accordance with the amount of a received light, and detects signals such as the FES, the TES and the RF on the basis of the electric signals. The second light receiving element 82 is placed on a light path of a diffraction light diffracted by the second hologram element 83 described later so as to be adjacent to the second light source 81 in a direction perpendicular to a light axis (occasionally simply referred to as a ‘second light axis’ hereafter) L22 of an application light emitted from the second light source 81 and applied to the optical recording medium 94. The first and second light receiving elements 73 and 82 are realized by, for example, photodiodes.

The first and second hologram elements 74 and 83 include three-beam diffraction gratings and hologram diffraction gratings, which are not shown in the drawing, respectively. The three-beam diffraction grating of the first hologram element 74 is formed on a surface of the first hologram element 74 that crosses the first light axis L11 at right angles and faces the first light source 72. The hologram diffraction grating of the first hologram element 74 is formed on a surface opposite to the surface on which the three-beam diffraction grating is formed. The three-beam diffraction grating of the second hologram element 83 is formed on a surface of the second hologram element 83 that crosses the second light axis L22 at right angles and faces the second light source 81. The hologram diffraction grating of the second hologram element 83 is formed on a surface opposite to the surface on which the three-beam diffraction grating is formed.

The three-beam diffraction grating diffracts the laser beam entering therein, thereby splitting the laser beam to one main beam and two sub beams. The hologram diffraction grating has a diffraction characteristic of diffracting the laser beam entering therein. The hologram diffraction grating of the first hologram element 74 diffracts the light emitted from the first light source 72, reflected by the information recording surface of the optical recording medium 94 and entering therein in a predetermined direction of the first light receiving element 73. The hologram diffraction grating of the second hologram element 83 diffracts the light emitted from the second light source 81, reflected by the information recording surface of the optical recording medium 94 and entering therein in a predetermined direction of the second light receiving element 82.

The first light source 72 and the first light receiving element 73 are placed on the side of one surface of the first stem 75, and the second light source 81 and the second light receiving element 82 are placed on the side of one surface of the second stem 84. The first lead electrode 76 is disposed so as to protrude from the side of another surface of the first stem 75, and electrically connected to the first light source 72. The second lead electrode 85 is disposed so as to protrude from the side of another surface of the second stem 84, and electrically connected to the second light source 81. When a driving voltage and a driving current are supplied to the first light source 72 via the first lead electrode 76, the laser beam of the red wavelength is emitted from the first light source 72. When a driving voltage and a driving current are supplied to the second light source 81 via the second lead electrode 85, the laser beam of the infrared wavelength is emitted from the second light source 81.

The first cap 77 is a sealing member for sealing in the first light source 72 and the first light receiving element 73 so as to avoid physical contact of the first light source 72 and the first light receiving element 73 with the outside, and mounted on the side of the one surface of the first stem 75. Consequently, the first light source 72 and the first light receiving element 73 are sealed off by the first stem 75 and the first cap 77. The second cap 86 is a sealing member for sealing in the second light source 81 and the second light receiving element 82 so as to avoid physical contact of the second light source 81 and the second light receiving element 82 with the outside, and mounted on the side of the one surface of the second stem 84. Consequently, the second light source 81 and the second light receiving element 82 are sealed off by the second stem 84 and the second cap 86.

The first light blocking aperture 79 serving as the light blocking member blocks, of the laser beam emitted from the first light source 72, unnecessary lights other than the application light applied from the first light source 72 to the optical recording medium 94 and a reflection light reflected by the information recording surface of the light recording medium 94 and received by the first light receiving element 73. The beam splitter 90 transmits a light entering from one side, and totally reflects a light entering from the other side at a reflection angle of 90 degrees. In the embodiment, the first light blocking aperture 79 is placed on the light path between the first hologram element 74 and the beam splitter 90, which is an optical component that is the closest to the first hologram element 74.

The second light blocking aperture 88 serving as the light blocking member blocks, of the laser beam emitted from the second light source 81, unnecessary lights other than the application light applied from the second light source 81 to the optical recording medium 94 and a reflection light reflected by the information recording surface of the light recording medium 94 and received by the second light receiving element 82. In the embodiment, the second light blocking aperture 88 is placed on the light path between the second hologram element 83 and the beam splitter 90, which is an optical component that is the closest to the second hologram element 83.

The first and second light blocking apertures 79 and 88 are made of a polycarbonate (abbreviated as PC) resin, an acrylonitrile-butadiene-styrene copolymer (abbreviated as ABS) resin, a polyphenylene sulfide (abbreviated as PPS) resin or the like.

The collimating lens 91 collimates the laser beam emitted from the first light source 72 and passing through the first hologram element 74, the first light blocking aperture 79 and the beam splitter 90, and the laser beam emitted from the second light source 81 and passing through the second hologram element 83, the second light blocking aperture 88 and the beam splitter 90, and guides to the objective lens 92 described later. The objective lens 92 condenses the lights from the beam splitter 90 to the information recording surface of the optical recording medium 94. In the embodiment, the beam splitter 90, the collimating lens 91 and the objective lens 92 are placed, respectively, on a light path extending in a direction of the first light axis L11 and between the first hologram element 74 and the optical recording medium 94. In the embodiment, the beam splitter 90, the collimating lens 91 and the objective lens 92 are equivalent to light guiding means. The housing 93 holds the first and second hologram units 78 and 87, the beam splitter 90, the collimating lens 91, and the objective lens 92.

In the optical pickup apparatus 71, the unnecessary lights other than the application light applied from the first light source 72 to the optical recording medium 94 and the reflection light reflected by the information recording surface of the optical recording medium 94 and received by the first light receiving element 73 of the laser beam emitted from the first light source 72, and the unnecessary lights other than the application light applied from the second light source 81 to the optical recording medium 94 and the reflection light reflected by the information recording surface of the optical recording medium 94 and received by the second light receiving element 82 of the laser beam emitted from the second light source 81, are reflected by an inner wall surface of the housing 93 and an optical component such as the beam splitter 90, whereby a so-called stray light is generated.

It is thought that detection of signals such as the FES, the TES and the RF is often affected specifically when, of the stray light, a stray light (occasionally referred to as a ‘first stray light’ hereafter) B1 generated by reflection by the optical component that is the closest to the hologram element 74 of the first hologram unit 78, that is, the beam splitter 90 in the embodiment enters into the first light receiving element, and a stray light (occasionally referred to as a ‘third stray light’ hereafter) B3 generated by reflection by the optical component that is the closest to the hologram element 83 of the second hologram unit 87, that is, the beam splitter 90 in the embodiment enters into the second light receiving element 82.

Accordingly, in the embodiment, the first light blocking aperture 79 is placed on the light path between the first hologram element 74 of the first hologram unit 78 and the beam splitter 90 of the optical component that is the closest to the first hologram element 74, and the second light blocking aperture 88 is placed on the light path between the second hologram element 83 of the second hologram unit 87 and the beam splitter 90 of the optical component that is the closest to the second hologram element 83.

The stray lights generated in the optical pickup apparatus 71 are not only the first and third stray lights B1 and B3, but also a stray light (occasionally referred to as a ‘second stray light’ hereafter) B2 generated when the laser beam emitted from the first light source 72 is reflected by the surface of the first light blocking aperture 79 placed for blocking the first stray light B1, the surface crossing the direction of the first light axis L11 at right angles and facing the first light source 72, and a stray light (occasionally referred to as a ‘fourth stray light’ hereafter) B4 generated when the laser beam emitted from the second light source 81 is reflected by the surface of the second light blocking aperture 88 placed for blocking the third stray light B3, the surface crossing the second light axis L22 at right angles and facing the second light source 81.

Accordingly, in the embodiment, on the surface of the first light blocking aperture 79 that crosses the direction of the first light axis L11 at right angles and faces the first light source 72, a first unnecessary light guiding surface 79a for guiding the second stray light B2 in a direction other than a direction of the first light receiving element 73 is formed. The first unnecessary light guiding surface 79a of the first light blocking aperture 79 in the embodiment is a curved surface having a concave shape in the same manner of the first embodiment according to the invention. Describing in detail, in the first unnecessary light guiding surface 79a, a portion from a central portion in a direction perpendicular to the first light axis L11 in the first light blocking aperture 79 (occasionally referred to as the ‘longitudinal direction’ hereafter) to both end portions in the longitudinal direction is curved like an arc so as to separate, toward one side in a thickness direction facing the hologram element 74 close to the hologram 74 of the first light blocking aperture 79, from another side in the thickness direction opposite to the one side in the thickness direction as it goes to both the end portions in the longitudinal direction. The first light blocking aperture 79 provided with the unnecessary light guiding surface 79a is formed by, for example, injection molding.

Further, in the embodiment, on the surface of the second light blocking aperture 88 that crosses the second light axis L22 at right angles and faces the second light source 81, a second unnecessary light guiding surface 88a for guiding the fourth stray light B4 in a direction other than a direction of the second light receiving element 82 is formed. The second unnecessary light guiding surface 88a of the second light blocking aperture 88 in the embodiment is a curved surface having a concave shape in the same manner of the first embodiment according to the invention. Describing in detail, in the second unnecessary light guiding surface 88a, a portion from a central portion in a direction perpendicular to the second light axis L22 in the second light blocking aperture 88 (occasionally referred to as the ‘longitudinal direction’ hereafter) to both end portions in the longitudinal direction is curved like an arc so as to separate, toward one side in a thickness direction facing the hologram element 83 close to the hologram element 83 of the second light blocking aperture 88, from another side in the thickness direction opposite to the one side in the thickness direction as it goes to both the end portions in the longitudinal direction. The second light blocking aperture 88 provided with the unnecessary light guiding surface 88a is formed by, for example, injection molding.

When the driving voltage and the driving current are supplied to the first light source 72 via the first lead electrode 76 disposed to the first stem 75, the laser beam of the red wavelength is emitted from the first light source 72. The laser beam emitted from the first light source 72 enters into the three-beam diffraction grating of the first hologram element 74. The laser beam entering into the three-beam diffraction grating is split to one main beam and two sub beams. In a description below, when at least one of the main beam and the respective sub beams is mentioned, it may be simply referred to as ‘light.’

The light passing through the three-beam diffraction grating enters into the hologram diffraction grating of the first hologram element 74. The light entering into the hologram diffraction grating is diffracted in a specified diffraction direction. The light passing through the first hologram element 74 passes through the first light blocking aperture 79 and the beam splitter 90, and enters into the collimating lens 91. The light entering into the collimating lens 91 is collimated. The light collimated by the collimating lens 91 enters into the objective lens 92. The objective lens 92 condenses the incident light to the information recording surface of the optical recording medium 94.

The light applied from the first light source 72 to the optical recording medium 94 and reflected by the information recording surface of the optical recording medium 94 tracks back the same light path as an approach route. The light reflected by the information recording surface of the optical recording medium 94 enters into the objective lens 92 to be collimated, passes through the collimating lens 91, the beam splitter 90 and the first light blocking aperture 79, and enters into the hologram diffraction grating of the first hologram element 74. The light entering into the hologram diffraction grating after being reflected by the information recording surface of the optical recording medium 94 is diffracted, and enters into the first light receiving element 74.

When the driving voltage and the driving current are supplied to the second light source 81 via the second lead electrode 85 disposed to the second stem 84, the laser beam of the infrared wavelength is emitted from the second light source 81. The laser beam emitted from the second light source 81 enters into the three-beam diffraction grating of the second hologram element 83. The laser beam entering into the three-beam diffraction grating is split to one main beam and two sub beams.

The light passing through the three-beam diffraction grating enters into the hologram diffraction grating of the second hologram element 83. The light entering into the hologram diffraction grating is diffracted in a specified diffraction direction. The light passing through the second hologram element 83 passes through the second light blocking aperture 88, is bent 90 degrees by the beam splitter 90, and enters into the collimating lens 91. The light entering into the collimating lens 91 is collimated. The light collimated by the collimating lens 91 enters into the objective lens 92. The objective lens 92 condenses the incident light to the information recording surface of the optical recording medium 94.

The light applied from the second light source 81 to the optical recording medium 94 and reflected by the information recording surface of the optical recording medium 94 tracks back the same light path as an approach route. The light reflected by the information recording surface of the optical recording medium 94 enters into the objective lens 92 to be collimated, passes through the collimating lens 91, is bent 90 degrees by the beam splitter 90, passes through the second light blocking aperture 88, and enters into the hologram diffraction grating of the second hologram element 83. The light entering into the hologram diffraction grating after being reflected by the information recording surface of the optical recording medium 94 is diffracted, and enters into the second light receiving element 82.

According to the embodiment, the first light blocking aperture 79 is placed on the light path between the first hologram element 74 and the beam splitter 90 of the optical component that is the closest to the first hologram element 74, so that the first stray light B1 generated when the light emitted from the first light source 72 is reflected by, for example, the beam splitter 90 is blocked by the first light blocking aperture 79. Therefore, it is possible to securely prevent the first stray light B1 from entering into the first light receiving element 73, and it is possible to stably detect the focus error signal, the tracking error signal and the information signal.

Further, according to the embodiment, the second light blocking aperture 88 is placed on the light path between the second hologram element 83 and the beam splitter 90 of the optical component that is the closest to the second hologram element 83, so that the third stray light B3 generated when the light emitted from the second light source 81 is reflected by, for example, the beam splitter 90 is blocked by the second light blocking aperture 88. Therefore, it is possible to securely prevent the third stray light B3 from entering into the second light receiving element 82, and it is possible to stably detect the focus error signal, the tracking error signal and the information signal.

Furthermore, in the embodiment, the first unnecessary light guiding surface 79a, which is a curved surface having a concave shape, is formed on the surface of the first light blocking aperture 79 that crosses the first light axis L11 at right angles and faces the first light source 72, so that it is possible to guide the second stray light B2 generated when the light emitted from the first light source 72 is reflected by the first unnecessary light guiding surface 79a, in the direction other than the direction of the first light receiving element 73. Consequently, it is possible to securely prevent the second stray light B2 from entering into the first light receiving element 73, and it is possible to stably detect the focus error signal, the tracking error signal and the information signal.

Further, considering a case where a scattering light is generated because the first unnecessary light guiding surface 79a of the first light blocking aperture 79 is rough, the first unnecessary light guiding surface 79a may be formed by a reflection preventing treatment in order to prevent generation of the scattering light. The reflection preventing treatment is, for example, to form a reflection preventing film on the surface of the first light blocking aperture 79 that faces the first light source 72, or to apply surface processing to the surface of the first light blocking aperture 79 that faces the first light source 72.

In the case of forming the reflection preventing film, for example, black matte lacquer is sprayed and applied to the surface of the first light blocking aperture 79 that faces the first light source 72. Moreover, in the case of applying the surface processing, by applying a so-called unevenness treatment by etching to a surface of a die used at the time of injection molding, microscopic asperities are formed on the surface of the die.

By forming the first unnecessary light guiding surface 79a by the reflection preventing treatment described above, the laser beam emitted from the first light source 72 is not reflected but absorbed by the first unnecessary light guiding surface 79a. Therefore, it is possible to prevent generation of the scattering light. Accordingly, it is possible to prevent the scattering light from entering into the first light receiving element 73, and it is possible to stably detect the focus error signal, the tracking error signal and the information signal.

Furthermore, in the embodiment, the second unnecessary light guiding surface 88a, which is a curved surface having a concave shape, is formed on the surface of the second light blocking aperture 88 that crosses the second light axis L22 at right angles and faces the second light source 81, so that it is possible to guide the fourth stray light B4 generated when the light emitted from the second light source 81 is reflected by the second unnecessary light guiding surface 88a, in the direction other than the direction of the second light receiving element 82. Consequently, it is possible to securely prevent the fourth stray light B4 from entering into the second light receiving element 82, and it is possible to stably detect the focus error signal, the tracking error signal and the information signal.

Further, considering a case where the scattering light is generated because the second unnecessary light guiding surface 88a of the second light blocking aperture 88 is rough, the second unnecessary light guiding surface 88a may be formed by the reflection preventing treatment in order to prevent generation of the scattering light. The reflection preventing treatment is, for example, to form the reflection preventing film on the surface of the second light blocking aperture 88 that faces the second light source 81, or to apply the surface processing to the surface of the second light blocking aperture 88 that faces the second light source 81.

In the case of forming the reflection preventing film, for example, black matte lacquer is sprayed and applied to the surface of the second light blocking aperture 88 that faces the second light source 81. Moreover, in the case of applying the surface processing, by applying the so-called unevenness treatment by etching to the surface of the die used at the time of injection molding, microscopic asperities are formed on the surface of the die.

By forming the second unnecessary light guiding surface 88a by the reflection preventing treatment described above, the laser beam emitted from the second light source 81 is not reflected but absorbed by the second unnecessary light guiding surface 88a. Therefore, it is possible to prevent generation of the scattering light. Accordingly, it is possible to prevent the scattering light from entering into the second light receiving element 82, and it is possible to stably detect the focus error signal, the tracking error signal and the information signal.

In the embodiment, the first light blocking aperture 79 may be formed in one body with the beam splitter of the optical component that is the closest to the first hologram element 74 of the first hologram unit 78, and the second light blocking aperture 88 may be formed in one body with the beam splitter 90 of the optical component that is the closest to the second hologram element 83 of the second hologram unit 87. For example, the first and second light blocking apertures 79 and 88 are formed in a beam splitter holder, which is not shown in the drawing, used at the time of installation of the beam splitter 90 into the housing 93, and the beam splitter holder in which the first and second light blocking apertures 79 and 88 are formed and the beam splitter 90 are integrated and installed into the housing 93.

By forming the first and second light blocking apertures 79 and 88 in one body with the beam splitter 90 of the optical component that is the closest to the respective hologram elements 74 and 83 of the first and second hologram units 78 and 87 as described above, the component count of the optical components and the number of the assembly processes at the time of production are reduced, and an optical adjustment operation such as an adjustment of a light axis is simplified, with the result that it is possible to increase the productivity of the optical pickup apparatus 71.

Further, in the embodiment, as in the sixth embodiment of the invention, the first light blocking aperture 79 may be formed in one body with the first hologram element 74 of the first hologram unit 78, and the second light blocking aperture 88 may be formed in one body with the second hologram element 83 of the second hologram unit 87. At the time of assembly of the optical pickup apparatus 71, it is necessary to perform the optical adjustment operation such as an adjustment of light axes of the first and second hologram units 78 and 87. The optical adjustment operation of the first and second hologram units 78 and 87 is performed by fitting the first and second hologram units 78 and 87 into first and second hologram unit holders not shown in the drawing for holding the first and second hologram units 78 and 87, and grasping the first and second hologram unit holders.

Then, by forming the first light blocking aperture 79 in the first hologram unit holder, and fitting the first hologram unit 78 into the first hologram unit holder in which the first light blocking aperture 79 is formed, the first light blocking aperture 79 and the first hologram element 74 of the first hologram unit 78 are integrated. Moreover, by forming the second light blocking aperture 88 in the second hologram unit holder, and fitting the second hologram unit 87 into the second hologram unit holder in which the second light blocking aperture 88 is formed, the second light blocking aperture 88 and the second hologram element 83 of the second hologram unit 87 are integrated.

By forming the first light blocking aperture 79 in one body with the first hologram element 74 of the first hologram unit 78 and forming the second blocking aperture 88 in one body with the second hologram element 83 of the second hologram unit 87 as described above, the component count of the optical components and the number of the assembly processes at the time of production are reduced, and the optical adjustment operation such as the adjustment of the light axis is simplified, with the result that it is possible to increase the productivity of the optical pickup apparatus 71.

Furthermore, in the embodiment, as in the seventh embodiment of the invention, the first and second light blocking apertures 79 and 88 may be formed in one body with the housing 93. By forming the first and second light blocking apertures 79 and 88 in one body with the housing 93, the component count of the optical components and the number of the assembly processes at the time of production are reduced, and the optical adjustment operation such as the adjustment of the light axis is simplified, with the result that it is possible to increase the productivity of the optical pickup apparatus 71.

Further, by reducing the component count of the optical components as described above, it is possible to make the optical pickup apparatus 71 small in size and light in weight, and it is possible to decrease the manufacturing cost of the optical pickup apparatus 71.

The embodiments described above merely exemplify the invention, and the structures thereof can be changed within the scope of the invention. For example, in the description of the optical pickup apparatus 71, light blocking apertures that are the same as the light blocking aperture 29 used in the optical pickup apparatus 21 are used as the first and second light blocking apertures 79 and 88, but another embodiment of the invention can be suitably embodied even if one of the light blocking apertures 42, 52 and 62 used in the optical pickup apparatuses 41, 51 and 61, respectively, is used in the optical pickup apparatus 71.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

1. An optical pickup apparatus comprising:
a hologram unit having a light source for emitting a laser beam of a predetermined wavelength band, a hologram element for diffracting the laser beam entering therein, and a light receiving element that is placed on a light path of a diffraction light diffracted by the hologram element so as to be adjacent to the light source in a direction perpendicular to a light axis of the laser beam; and
a light blocking member that is placed on the light path between the hologram element and an optical recording medium in correspondence to the hologram element of the hologram unit, the light blocking member blocking, of the laser beam, unnecessary lights other than an application light applied from the light source to the optical recording medium and a reflection light reflected by the optical recording medium and received by the light receiving element,
wherein the light blocking member has an unnecessary light guiding surface formed to face the light source, for guiding the unnecessary lights other than the application light and the reflection light in a direction other than a direction of the light receiving element.

2. The optical pickup apparatus of claim 1, wherein the unnecessary light guiding surface of the light blocking member is a curved surface.

3. The optical pickup apparatus of claim 1, wherein the unnecessary light guiding surface of the light blocking member is a flat surface that forms an angle other than a right angle with respect to the light axis of the laser beam.

4. The optical pickup apparatus of claim 1, wherein the unnecessary light guiding surface of the light blocking member is a curved concave surface that faces the light receiving element.

5. The optical pickup apparatus of claim 1, wherein the unnecessary light guiding surface of the light blocking member is a flat surface that faces the light receiving element and forms an angle other than a right angle with respect to the light axis of the application light.

6. The optical pickup apparatus of claim 1, further comprising:
light guiding means for guiding the laser beam emitted from the light source to the optical recording medium,
wherein the light guiding means is placed on the light path between the hologram element and the optical recording medium, and
the light blocking member is placed on the light path between the hologram element and the light guiding means.

7. The optical pickup apparatus of claim 6, wherein the light blocking member is formed in one body with the light guiding means.

8. The optical pickup apparatus of claim 1, wherein the light blocking member is formed in one body with the hologram element.

9. The optical pickup apparatus of claim 1, further comprising:
a housing for holding the hologram unit,
wherein the light blocking member is formed in one body with the housing.

10. The optical pickup apparatus of claim 1, wherein the unnecessary light guiding surface of the light blocking member is formed by a reflection preventing treatment for preventing reflection of the applied laser beam.

11. The optical pickup apparatus of claim 1, further comprising a beam splitter,
wherein a plurality of the hologram units and a plurality of the light blocking members are provided.
